(19) United States
(12) Patent Application Publication
(10) Pub. No.: US 2025/0194823 A1
(43) Pub. Date: Jun. 19, 2025

(54) DISPLAY DEVICES

(71) Applicant: SHENZHEN SHOKZ CO., LTD., Shenzhen (CN)

(72) Inventors: Yifeng GAN, Shenzhen (CN); Xinnan MAO, Shenzhen (CN); Peipei LIN, Shenzhen (CN); Xiaoyan LIN, Shenzhen (CN)

(73) Assignee: SHENZHEN SHOKZ CO., LTD., Shenzhen (CN)

(21) Appl. No.: 19/066,135

(22) Filed: Feb. 27, 2025

Related U.S. Application Data
(63) Continuation of application No. PCT/CN2023/087090, filed on Apr. 7, 2023.

(51) Int. Cl. A47F 3/14; A47F 3/06

(52) U.S. Cl. CPC A47F 3/14; A47F 3/06

(57) ABSTRACT

The present disclosure provides a display device, including a display stand, a wire and a first displayed object. The display stand is equipped with a main control circuit board, and the first displayed object is able to be experienced by a user and is connected to the main control circuit board through the wire.

### CROSS-REFERENCE TO RELATED APPLICATIONS

This application is a continuation of International Patent Application No. PCT/CN2023/087090, filed on Apr. 7, 2023, the contents of which are hereby incorporated by reference.

### TECHNICAL FIELD

The present disclosure relates to the technical field of electronic devices, and in particular, to a display device.

### BACKGROUND

With the continuous popularization of electronic devices, electronic devices are becoming indispensable social and entertainment tools in people's daily lives, and people's requirements for electronic devices are also increasing. Electronic devices such as earphones and smart glasses are widely used in people's daily lives. These electronic devices can be used in conjunction with terminal devices such as cell phones, computers, etc., to provide users with an auditory feast. In particular, these devices can be displayed and sold in major shopping malls, specialty stores, exhibitions, etc. These places usually set up display devices for publicizing and showcasing the relevant products to attract users to come and experience them.

### SUMMARY

Embodiments of the present disclosure provide a display device including a display stand, a wire, and a first displayed object. The display stand is equipped with a main control circuit board, and the first displayed object is able to be experienced by a user and is connected to the main control circuit board through the wire.

In some embodiments, the display stand includes a first display shelf, a second display shelf and a fastener, the first display shelf including a first bottom plate, and a first side plate and a protruding platform connected to the first bottom plate. The protruding platform and the first side plate are located on a same side of the first bottom plate. The protruding platform is disposed with a first through hole section and a second through hole section, as well as a third through hole section connecting the first through hole section and the second through hole section. The second through hole section is further away from the first bottom plate than the first through hole section. The third through hole section has a smallest hole diameter among the first through hole section, the second through hole section, and the third through hole section. The fastener includes a head portion, a bare bar portion connected to the head portion, and a threaded portion connected to the bare bar portion. A diameter of the threaded portion is greater than a hole diameter of the third through hole section and less than a smaller one of a hole diameter of the first through hole section and a hole diameter of the second through hole section, and the fastener is configured to pass through the second through hole section, the third through hole section, and the first through hole section, and is threadedly connected to the second display shelf through the threaded portion.

In some embodiments, a ratio of a depth of the third through hole section to a length of the threaded portion is in a range of 0.6-1.

In some embodiments, the bare bar portion includes a first bare bar section and a second bare bar section. The first bare bar section is closer to the threaded portion compared to the second bare bar section, a diameter of the first bare bar section is less than a diameter of the second bare bar section, and the diameter of the second bare bar section is greater than the hole diameter of the third through hole section.

In some embodiments, the ratio between the hole diameter of the second through hole section and the diameter of the second bare bar section is between 0.2 and 0.4.

In some embodiments, a ratio of a length of the first bare bar section to a sum of a depth of the first through hole section and a depth of the third through hole section is in a range of 1-1.5.

In some embodiments, the depth of the first through hole section is greater than or equal to a length of the threaded portion, and a depth of the second through hole section is greater than or equal to a length of the second bare bar section.

In some embodiments, a ratio of a height of the protruding platform to a height of the first side plate is in a range of 0.7-1, and a minimum spacing between a center of any one of the second through hole section, the third through hole section, and the first through hole section of the protruding platform and the first side plate is in a range of 10 mm-12 mm.

In some embodiments, a depth of the third through hole section is in a range of 2 mm-4 mm.

In some embodiments, the second display shelf includes a second bottom plate and a second side plate connected to the second bottom plate, the protruding platform is disposed in a region where the first bottom plate overlaps the second side plate, and the fastener makes the first bottom plate to abut against the second side plate.

In some embodiments, the first display shelf includes a partition plate connected to the first bottom plate, the partition plate divides a first accommodation space enclosed by the first side plate and the first bottom plate into a first accommodation sub-region and a second accommodation sub-region, a volume of the first accommodation sub-region is less than a volume of the second accommodation sub-region, and the protruding platform is located in the first accommodation sub-region and connected to the first side plate and the partition plate respectively through one or more reinforcement bars.

In some embodiments, the first side plate and the first bottom plate enclose a first accommodation space, and the second side plate and the second bottom plate enclose a second accommodation space. There are a plurality of protruding platforms, a plurality of through hole pairs are disposed in the region where the first bottom plate overlaps the second side plate, the plurality of through hole pairs and the plurality of protruding platforms are alternately arranged, and each of the plurality of through hole pairs enables the first accommodation space to be communicated with the second accommodation space.

In some embodiments, the main control circuit board is disposed in the second display shelf, the display stand includes a light bar disposed in the first display shelf, a wire connected to the light bar, and a power switch and an adapter socket disposed in the second display shelf, an end of the wire away from the light bar is provided with an adapter plug, the power switch is connected to the main control circuit board and is exposed through one through hole pair, the adapter socket is connected to the main control circuit board and is exposed through another through hole pair, the adapter plug is plug-connected to the adapter socket, and a light emitted from the light bar is able to pass through a light transmission region of the first bottom plate.

In some embodiments, a side of the second bottom plate away from the second side plate is divided into a first display region and a second display region, the display stand includes a showcase which is located in the first display region and is removably connected to the second bottom plate, the showcase is used to display a second displayed object that cannot be experienced by the user, so as to allow the showcase and the second displayed object to be taken as a replaceable module, and the second display region is used to display the first displayed object.

In some embodiments, the display stand includes a display shelf, a key assembly, and an auxiliary circuit board. The display shelf is used to display the first displayed object, and includes a bottom plate and a side plate connected to the bottom plate, the key assembly includes a plurality of keys and one or more connecting bars connecting the plurality of keys, the one or more connecting bars allows any key of the plurality of keys to be movable under an external force, the key assembly is connected to the bottom plate through the one or more connecting bars, and makes the plurality of keys to expose through holes on the bottom plate respectively, each of the plurality of keys includes a cylindrical sidewall connected to the one or more connecting bars and an end wall integrally connected to one end of the cylindrical sidewall, the end wall is disposed with hollow graphics, the key assembly includes light-transmitting members installed inside the plurality of keys, the light-transmitting members allow light to pass through, each of the light-transmitting member includes a columnar body and a graphic protrusion connected to the columnar body, the columnar body is disposed in the cylindrical sidewall, the graphic protrusion is disposed in the hollow graphics, the auxiliary circuit board is located on a side of the key assembly away from the bottom plate, and is connected to the bottom plate, the auxiliary circuit board is disposed with a plurality of switching devices and a plurality of light beads, the plurality of the switching devices are disposed in a one-to-one correspondence with the plurality of keys, the plurality of keys trigger the corresponding switching devices through the light-transmitting member under an action of the external force to control the first displayed object, each of the plurality of keys is disposed corresponding to at least one of the plurality of light beads, and a light transmitted from the plurality of light beads is transmitted through the corresponding light-transmitting member.

In some embodiments, all of the plurality of keys and the one or more connecting bars are divided into single key blocks with a same count as the plurality of keys. Each of single key blocks includes one of the plurality of keys and two of the one or more connecting bars, an end of each of the one or more connecting bars not connected to the plurality of keys is provided with a support block, and the support block contacts the auxiliary circuit board to allow the one or more connecting bars to be in a suspended state relative to the auxiliary circuit board.

In some embodiments, two adjacent single key blocks share one support block, and when viewed in a pressing direction of the key assembly, geometric centers of all of the support blocks and geometric centers of all the plurality of keys are set to be co-linear.

In some embodiments, when viewed along the pressing direction, each connecting bar is set in an arc shape, and the two connecting bars in each single key block is set to be rotationally symmetrical.

In some embodiments, two support blocks with a greatest space among all of the support blocks are each provided with a mounting hole to allow the key assembly to be fixed at the mounting hole.

In some embodiments, at least one of the light-transmitting members includes a cylindrical outer wall and a columnar inner core connected to an end of the columnar body away from the graphic protrusion. The columnar inner core is disposed at an inner side of the cylindrical outer wall, and used for triggering the switching device under the action of the external force, the cylindrical outer wall and the columnar inner core are further connected by a plurality of reinforcement bars spaced around the columnar inner core, the cylindrical sidewall is provided with a convex strip extending along an axial direction of the key on the inside of the cylindrical side wall, the cylindrical outer wall is provided with a groove extending in an axial direction along the light-transmitting member, the groove is located between two adjacent reinforcement bars in a circumferential direction of the light-transmitting member and makes at least a portion of the cylindrical outer wall discontinuous along the circumferential direction of the light-transmitting member, and the convex strip is disposed within the groove.

In some embodiments, the wire includes a first conductive core wire and a second conductive core wire electrically insulated from each other and an elastic covering wrapping the first conductive core wire and the second conductive core wire, the main control circuit board transmits signals to the first displayed object through the first conductive core wire and the second conductive core wire, the elastic covering has a resilience superior to a resilience of either of the first conductive core wire and the second conductive core wire to allow the wire to stretch under the resilience of the elastic covering after the elastic covering is coiled. The wire of length L1 is coiled two times with a diameter of 10 cm and then rested for 24 hours, and then a distance between two endpoints of the wire after stretching is measured to be L2, wherein L2/L1≥0.6.

In some embodiments, L2/L1≥0.8.

In some embodiments, a ratio of a wall thickness of the elastic covering to a total diameter of the first conductive core wire and the second conductive core wire is in a range of 0.2-0.25.

In some embodiments, the first conductive core wire is a multi-stranded wire, and the second conductive core wire is another multi-stranded wire twisted on the first conductive core wire.

In some embodiments, the elastic covering is a transparent structure, and the second conductive core wire is a multi-stranded wire and twisted on the first conductive core wire.

In some embodiments, the first displayed object includes earphones, and the wire is set as a Y-shaped wire to connect two earphones.

In some embodiments, there is a color difference between a color of the second conductive core wire and a color of the first displayed object.

In some embodiments, the main control circuit board is provided with a socket terminal, one end of the wire is provided with a plug terminal, and the plug terminal is plug-connected to the socket terminal to allow the first displayed object, the wire and the plug terminal to act as a replaceable module.

In some embodiments, a yellowness index of the elastic covering is level 0 or level 1.

In some embodiments, a material of the elastic covering includes a thermoplastic polyester elastomer.

### BRIEF DESCRIPTION OF THE DRAWINGS

To more clearly illustrate the technical solutions of the embodiments of the present disclosure, the following will briefly introduce the accompanying drawings that need to be used in the description of the embodiments, and it is obvious that the accompanying drawings in the following description are only some of the embodiments of the present disclosure, and other attachments are obtained accordingly without creative labor to those skilled in the art.

FIG. 1 is a schematic diagram illustrating a structure of a display device according to some embodiments of the present disclosure;

FIG. 2 is a schematic diagram illustrating a structure of a display stand in FIG. 1 according to some embodiments of the present disclosure;

FIG. 3 is a structural diagram illustrating a top view of a display stand in FIG. 1 according to some embodiments of the present disclosure;

FIG. 4 is a schematic diagram illustrating a partial structure of a display stand in FIG. 1 according to some embodiments of the present disclosure;

FIG. 5 is a schematic diagram illustrating a sectional structure of a display stand in FIG. 1 along a section A2-A2 direction according to some embodiments of the present disclosure;

FIG. 6 is a schematic diagram illustrating a structure of a fastener according to some embodiments of the present disclosure;

FIG. 7 is a schematic diagram illustrating a disassembled structure of a key assembly according to some embodiments of the present disclosure;

FIG. 8 is a schematic diagram illustrating a sectional structure of a display stand in FIG. 3 along a section A1-A1 direction according to some embodiments of the present disclosure;

FIG. 9 is a structural diagram illustrating a top view of a key assembly in FIG. 7 according to some embodiments of the present disclosure;

FIG. 10 is a schematic diagram illustrating a structure of a light-transmitting member in FIG. 7 according to some embodiments of the present disclosure;

FIG. 11 is a schematic diagram illustrating a structure of a light-transmitting member in FIG. 7 according to some embodiments of the present disclosure;

FIG. 12 is a schematic diagram illustrating a structure of a wire according to some embodiments of the present disclosure;

FIG. 13 is a schematic diagram illustrating a structure of a wire in FIG. 12 in different states according to some embodiments of the present disclosure; and

FIG. 14 is a schematic diagram illustrating a structure of a wire in FIG. 12 according to some embodiments of the present disclosure.

### DETAILED DESCRIPTION

In present disclosure is described in further detail below in conjunction with the accompanying drawings and embodiments. In particular, it is noted that the following embodiments are only used to illustrate the present disclosure, but do not limit the scope of the present disclosure. Similarly, the following embodiments are only part of the embodiments of the present disclosure and not all of the embodiments, and all other embodiments obtained by those skilled in the art without creative labor fall within the scope of protection of the present disclosure.

References to “embodiments” in the present disclosure mean that particular features, structures, or characteristics described in conjunction with embodiments are included in at least one embodiment of the present disclosure. It is understood by those skilled in the art, both explicitly and implicitly, that the embodiments described in the present disclosure are combined with other embodiments.

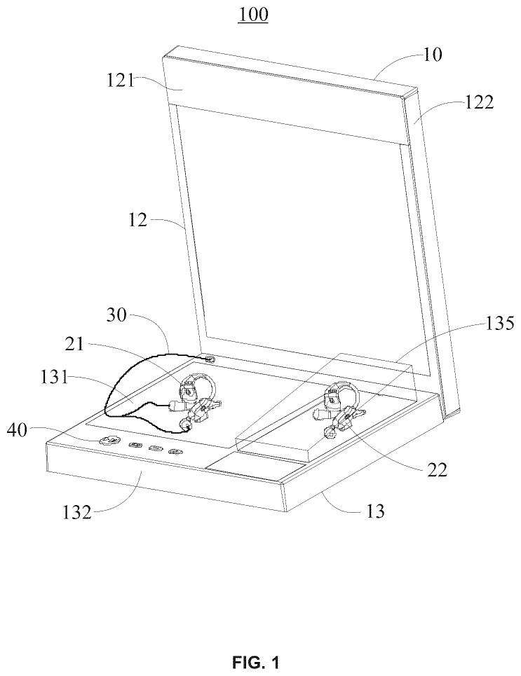

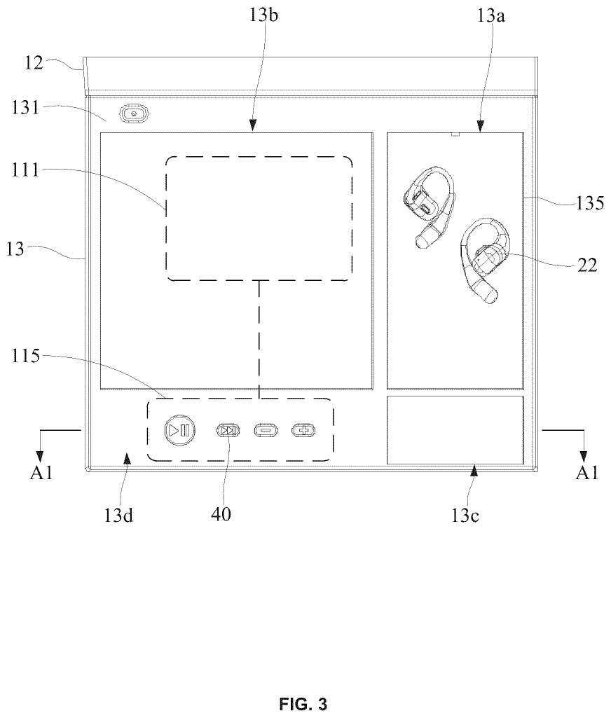

Merely by way of example, in conjunction with FIG. 1 to FIG. 3, a display device 100 includes a display stand 10, a displayed object 21 on the display stand 10, and a wire 30 connecting the displayed object 21 to the display stand 10. The displayed object 21 is able to be experienced by a user, e.g., the user wears the displayed object 21. Further, a main control circuit board 111 is disposed within the display stand 10, and the displayed object 21 is connected to the main control circuit board 111 through a wire 30 to allow the display stand 10 to transmit signals to the displayed object 21 through the wire 30, thereby facilitating the user to experience the displayed object 21. Based on this, the displayed object 21 may be an electronic device with an audio playback capability, such as an earphone, smart glasses, etc. In this way, when experiencing the displayed object 21, the user can control the displayed object 21 to play an audio file stored on the display device 100 by a key assembly 40, such as a play/pause key, a next song key, a volume down key, a volume up key, etc., so that the user does not need to connect his/her terminal device, such as a cell phone, which is simple, convenient, and beneficial for improving the user's experience towards the displayed object 21. It should be noted that when the displayed object 21 is an earphone, a charging case sold together with the earphone can be displayed together.

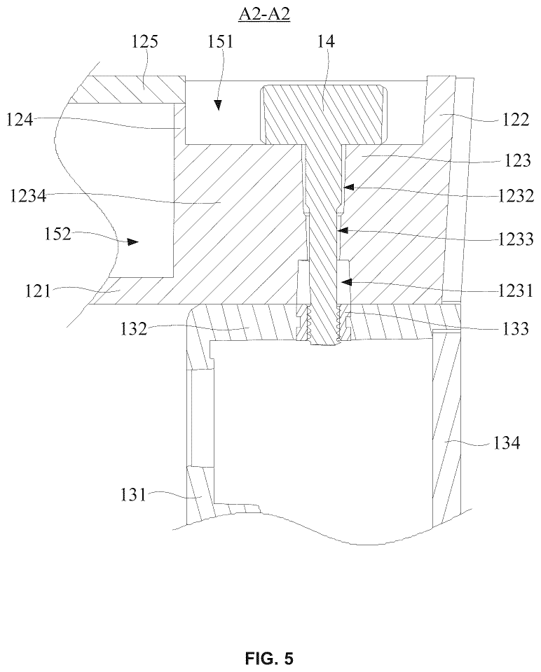

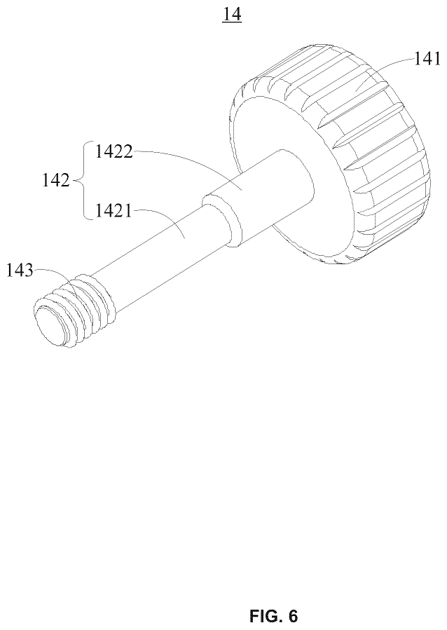

Exemplarily, referring to FIG. 1 to FIG. 6, the display stand 10 includes a display shelf 12, a display shelf 13, and a fastener 14. The fastener 14 enables the display shelf 12 and the display shelf 13 to be removably fixed together. The display shelf 12 includes a bottom plate 121, as well as a side plate 122 and a protruding platform 123 connected to the bottom plate 121. The protruding platform 123 and the side plate 122 are located at a same side of the bottom plate 121. Further, a first through hole section 1231, a second through hole section 1232, and a third through hole section 1233 connecting the first through hole section 1231 to the second through hole section 1232, are disposed on the protruding platform 123. The second through hole section 1232 is located further away from the bottom plate 121 compared to the first through hole section 1231. The third through hole section 1233 has the smallest hole diameter among the first through hole section 1231, the second through hole section 1232, and the third through hole section 1233. Correspondingly, the fastener 14 includes a head portion 141, a bare bar portion 142 connected to the head portion 141, and a threaded portion 143 connected to the bare bar portion 142. The diameter of the threaded portion 143 is greater than the hole diameter of the third through hole section 1233 and less than a smaller one of the hole diameter of the first through hole section 1231 and the hole diameter of the second through hole section 1232. The fastener 14 is configured to pass through the second through hole section 1232, the third through hole section 1233, and the first through hole section 1231, and is threadedly connected to the display shelf 13 through the threaded portion 143. In this way, as the protruding platform 123 is provided with the first through hole section 1231, the second through hole section 1232, and the third through hole section 1233 connecting the first through hole section 1231 to the second through hole section 1232, i.e., a three-section through hole, the three-section through hole enables a height of the protruding platform 123 relative to the bottom plate 121 to be higher, which is conducive to shortening a height difference between the protruding platform 123 and the side plate 122, so that the head portion 141 does not fall into the display shelf 12 too deeply after the fastener 14 is threaded through the protruding platform 123 and before the fastener 14 connects the display shelf 12 and the display shelf 13, thereby helping to reduce a risk of fingers of an assembler being interfered by the side plate 122 to allow the assembler to fix the display shelf 12 and the display shelf 13 together by finger-twisting the fastener 14. As the diameter of the threaded portion 143 is greater than the hole diameter of the third through hole section 1233 and less than the smaller one of the hole diameter of the first through hole section 1231 and the hole diameter of the second through hole section 1232, in a process of threading through the protruding platform 123, the fastener 14 only needs to self-tap the threads of the third through hole section 1233, that is, shorten a tapping distance, which helps to reduce the assembly difficulty of the fastener 14 and the display shelf 12. Alternatively, the third through hole section 1233 may also be pre-molded with threads, which also helps to shorten the distance of screwing the fastener 14, and reduce the assembly difficulty of the fastener 14 and the display shelf 12. Further, the fastener 14 is unlikely to disengage from the display shelf 12 when threading through the protruding platform 123, which helps to reduce the risk for the fastener 14 falling off or getting lost, and allows the threaded portion 143 to be at least partially accommodated within the first through hole section 1231 to allow the display shelf 12 and the display shelf 13 to be as close as possible before being fixed together by the fasteners 14, which reduces the assembly difficulty of the display stand 10.

In some embodiments, a ratio of a depth of the third through hole section 1233 to a length of the threaded portion 143 is in a range of 0.6-1. If the aforementioned ratio is too small, it is likely to make the fastener 14 difficult to be stopped by the third through hole section 1233 and detach from the display shelf 12 after threaded through the protruding platform 123. If the aforementioned ratio is too large, it can easily lead to excessive tapping distance, making it difficult to assemble the fastener 14 with the display shelf 12.

In some embodiments, the bare bar portion 142 includes a first bare bar section 1421 and a second bare bar section 1422. The first bare bar section 1421 is closer to the threaded portion 143 compared to the second bare bar section 1422. A diameter of the first bare bar section 1421 is less than a diameter of the second bare bar section 1422, and the diameter of the second bare bar section 1422 is greater than the hole diameter of the third through hole section 1233. In this way, as the second bare bar section 1422 is thicker than the first bare bar section 1421, a gap between the bare bar portion 142 and the third through hole section 1233 is narrowed, thereby reducing an amplitude of the fastener 14 wobbling within the protruding platform 123 and increasing the co-axiality between the fastener 14 and the protruding platform 123 to facilitate the assembly of the display stand 10. Based on this, a ratio of the hole diameter of the second through hole section 1232 and the diameter of the second bare bar section 1422 is in a range of 0.2-0.4. If the aforementioned ratio is too small, the fastener 14 is difficult to be threaded onto the protruding platform 123 due to the gap between the bare bar portion 142 and the third through hole section 1233 being too small, or the fastener 14 is too expensive due to the second bare bar section 1422 being too thick. If the aforementioned ratio is too large, the structural strength of the protruding platform 123 is insufficient as a wall thickness at the third through hole section 1233 is too small, and it is difficult for the fastener 14 to maintain a high co-axiality with the protruding platform 123 due to the gap between the second bare bar section 1422 and the third through hole section 1233 being too great, which is unfavorable to the subsequent connection between the display shelf 12 and the display shelf 13. A ratio of a length of the first bare bar section 1421 to a sum of a depth of the first through hole section 1231 and the depth of the third through hole section 1233 is in a range of 1-1.5. If the aforementioned ratio is too small, the reliability of the connection between the display shelf 12 and the display shelf 13 is insufficient due to a length of the threaded portion 143 extending into the display shelf 13 being too short. If the aforementioned ratio is too large, a length of the second bare bar section 1422 is too short to function as preset. The depth of the first through hole section 1231 is greater than or equal to the length of the threaded portion 143 to allow the threaded portion 143 to be fully accommodated within the first through hole section 1231, so that the display shelf 12 and the display shelf 13 are as close together as possible before being fixed together by the fastener 14, thereby reducing the assembly difficulty of the display stand 10. The depth of the second through hole section 1232 is greater than or equal to the length of the second bare bar section 1422 to allow the fastener 14 to be screwed into place when connecting the display shelf 12 and the display shelf 13.

In some embodiments, a ratio of a height of the protruding platform 123 to the height of the side plate 122 is in a range of 0.7-1. If the aforementioned ratio is too small, the height difference between the protruding platform 123 and the side plate 122 is too small, causing the head portion 141 to sink too deeply into the display shelf 12 after the fastener 14 is threaded through the protruding platform 123 and before the fastener 14 connects the display shelf 12 to the display shelf 13, which is not convenient for the assembler to fix the display shelf 12 and the display shelf 13 together by screwing the fastener 14 with fingers. If the aforementioned ratio is too large, the fastener 14 protrudes out too much after connecting the display shelf 12 and the display shelf 13.

In some embodiments, a minimum spacing between a center of any one of the second through hole section, the third through hole section, and the first through hole section of the protruding platform 123 and the side plate 122 is in a range of 10 mm-12 mm. If the aforementioned minimum distance is too small, the spacing between the head portion 141 and the side plat 122 is too small, which is inconvenient for the assembler to fix the display shelf 12 and the display shelf 13 together by screwing the fastener 14 with fingers. If the aforementioned minimum distance is too large, the thickness of the display shelf 13 is too large, which is not conducive to reducing a cost of the display stand 10.

In some embodiments, the depth of the third through hole section 1233 is in a range of 2 mm-4 mm. If the aforementioned depth is too small, it is likely to make the fastener 14 difficult to be stopped by the third through hole section 1233 and detach from the display shelf 12 after threaded through the protruding platform 123. If the aforementioned depth is too large, the aforementioned tapping distance is too large, which makes it difficult to assemble the fastener 14 with the display shelf 12.

Based on the above related descriptions, the present disclosure provides a connecting structure. The connecting structure includes a first to-be-connected member, a second to-be-connected member, and the fastener 14. The first to-be-connected member is provided with the first through hole section 1231, the second through hole section 1232, and the third through hole section 1233 connecting the first through hole section 1231 and the second through hole section 1232. The third through hole section 1233 has the smallest hole diameter among the first through hole section 1231, the second through hole section 1232, and the third through hole section 1233. Correspondingly, the fastener 14 includes a head portion 141, a bare bar portion 142 connected to the head portion 141, and a threaded portion 143 connected to the bare bar portion 142. A diameter of the threaded portion 143 is greater than the hole diameter of the third through hole section 1233 and less than a smaller one of the hole diameter of the first through hole section 1231 and the hole diameter of the second through hole section 1232. The fastener 14 is configured to pass through the second through hole section 1232, the third through hole section 1233, and the first through hole section 1231, and is threadedly connected to the foregoing second to-be-connected member through the threaded portion 143. In this way, as the diameter of the threaded portion 143 is greater than the hole diameter of the third through hole section 1233 and less than the smaller one of the hole diameter of the first through hole section 1231 and the hole diameter of the second through hole section 1232, in a process of threading through the above first to-be-connected member, the fastener 14 only needs to self-tap the threads of the third through hole section 1233, that is, shorten the tapping distance, which helps to reduce the assembly difficulty of the fastener 14 and the first to-be-connected member. Alternatively, the third through hole section 1233 may also be pre-molded with threads, which also helps to shorten the distance of screwing the fastener 14, and reduce the assembly difficulty of the fastener 14 and the first to-be-connected member. Further, the fastener 14 is unlikely to disengage from the display shelf 12 when threading through the first to-be-connected member, which helps to reduce the risk for the fastener 14 to fall off or get lost, and allows the threaded portion 143 to be at least partially accommodated within the first through hole section 1231 to allow the first to-be-connected member and the second to-be-connected member to be as close as possible before being fixed together by the fasteners 14, which reduces the assembly difficulty.

Further, the bare bar portion 142 includes a first bare bar section 1421 and a second bare bar section 1422. The first bare bar section 1421 is closer to the threaded portion 143 compared to the second bare bar section 1422. A diameter of the first bare bar section 1421 is less than a diameter of the second bare bar section 1422, and the diameter of the second bare bar section 1422 is greater than the hole diameter of the third through hole section 1233. In this way, as the second bare bar section 1422 is thicker than the first bare bar section 1421, a gap between the bare bar portion 142 and the third through hole section 1233 is narrowed, thereby reducing an amplitude of the fastener 14 wobbling within the first to-be-connected member and increasing the co-axiality between the fastener 14 and the first to-be-connected member to facilitate the following assembly.

Based on the foregoing relevant descriptions, the present disclosure provides the fastener 14 used to connect at least two to-be-connected members. Any one of the at least two to-be-connected members is provided with the first through hole section 1231, the second through hole section 1232, and the third through hole section 1233 connecting the first through hole section 1231 and the second through hole section 1232. The third through hole section 1233 has the smallest hole diameter among the first through hole section 1231, the second through hole section 1232, and the third through hole section 1233. Correspondingly, the fastener 14 includes the head portion 141, the bare bar portion 142 connected to the head portion 141, and the threaded portion 143 connected to the bare bar portion 142. The bare bar portion 142 includes the first bare bar section 1421 and the second bare bar section 1422. The first bare bar section 1421 is closer to the threaded portion 143 than the second bare bar section 1422. The threaded portion 143 has a diameter that is greater than the hole diameter of the third through hole section 1233 and less than the smaller one of the hole diameter of the first through hole section 1231 and the hole diameter of the second through hole section 1232. The fastener 14 is configured to pass through the second through hole section 1232, the third through hole section 1233, and the first through hole section 1231, and is threadedly connected to the other to-be-connected member through the threaded portion 143. In this way, as the second bare bar section 1422 is thicker than the first bare bar section 1421, the gap between the bare bar portion 142 and the third through hole section 1233 is narrowed, thereby reducing an amplitude of the fastener 14 wobbling within the to-be-connected member, and increasing the co-axiality between the fastener 14 and the to-be-connected member to facilitate the following assembly.

Merely by way of example, referring FIG. 1 to FIG. 6, the display shelf 13 includes a bottom plate 131 and a side plate 132 connected to the bottom plate 131. The protruding platform 123 is disposed in a region where the bottom plate 121 overlaps the side plate 132, and the fastener 14 makes the bottom plate 121 to abut against the side plate 132. In the region where the bottom plate 121 overlaps the side plate 132, at least one protrusion is provided on one of the display shelf 12 and the display shelf 13, and the other is provided with at least one groove for accommodating the at least one protrusion. The at least one protrusion and the at least one groove cooperate with each other to serve functions of fool-proofing, guiding, pre-fixing, etc.

It is noted that when the display shelf 13 is a plastic member, the display shelf 13 includes a threaded sleeve 133 made of metal, and the threaded sleeve 133 is embedded within the aforementioned plastic member. The fastener 14 is threadedly connected to the threaded sleeve 133 through the threaded portion 143 in connecting the display shelf 12 and the display shelf 13, which is conducive to increasing the reliability of the connection.

In some embodiments, the display shelf 12 includes a partition plate 124 connected to the bottom plate 121. The partition plate 124 divides a first accommodation space enclosed by the first side plate 122 and the first bottom plate 121 into a first accommodation sub-region 151 and a second accommodation sub-region 152, and a volume of the first accommodation sub-region 151 is smaller than a volume of the second accommodation sub-region 152. The protruding platform 123 is located in the first accommodation sub-region 151 and is connected to the side plate 122 and the partition plate 124, respectively, through one or more reinforcement bars 1234, so as to improve the structural strength of the display shelf 12 at the protruding platform 123, which is conducive to increasing the reliability of the connection between the display shelf 12 and the display shelf 13. Further, the display shelf 12 includes a cover plate 125 disposed over an open end of the second accommodation sub-region 152 to allow the second accommodation sub-region 152 to act as a relatively closed accommodation space.

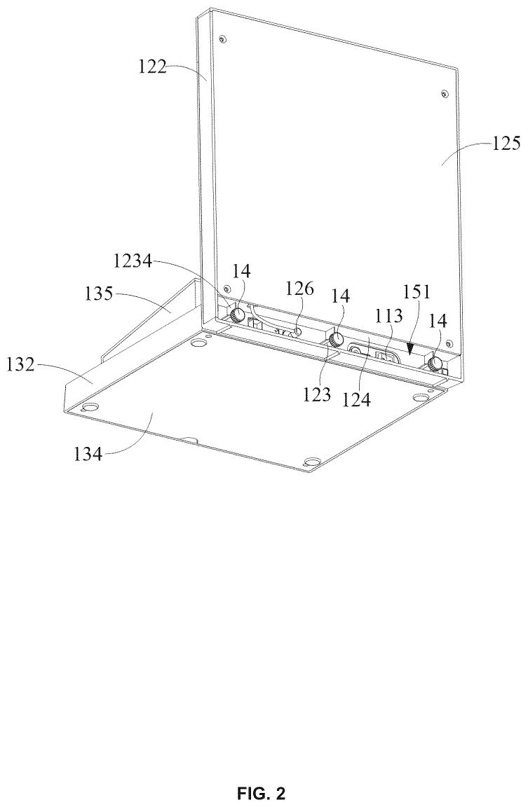

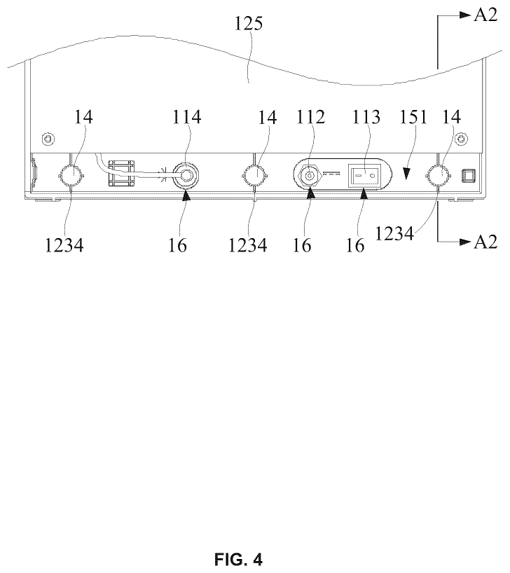

In some embodiments, the side plate 122 and the bottom plate 121 are disposed to enclose a first accommodation space, and the side plate 132 and the bottom plate 131 are disposed to enclose a second accommodation space. Similarly, the display shelf 12 includes the cover plate 125 disposed over an open end of the first accommodation space away from the bottom plate 121 to allow the display shelf 12 to have a relatively enclosed accommodation space. The display shelf 13 includes a cover plate 134 disposed over an open end of the second accommodation space away from the bottom plate 131 to allow the display shelf 13 to have a relatively closed accommodation space. Accordingly, the main control circuit board 111 is disposed within the display shelf 13, and the first accommodation space and the second accommodation space are also respectively provided with other electronics required for the display stand 10. Furthermore, there are a plurality of protruding platforms 123. For example, three protruding platforms 123 as shown in FIG. 2 and FIG. 4. The region where the bottom plate 121 overlaps the side plate 132 is provided with a plurality of through hole pairs 16, for example, three through hole pairs 16 as shown in FIG. 2 and FIG. 4. The plurality of through hole pairs 16 and the plurality of protruding platforms 123 are alternately arranged, e.g., there is at least one through hole pair 16 between two adjacent protruding platforms 123, so that a spacing between the two adjacent protruding platforms 123 is relatively large to allow the display stand 10 to be assembled with less fasteners 14. Further, each of the through hole pairs 16 makes the first accommodation space to be connected to the second accommodation space, respectively to allow for the exposure of the electronics within the display shelf 13 that are connected to the main control circuit board 111 and allow for the connection between the electronics within the display shelf 12 and the main control circuit board 111. For example, the display stand 10 includes a light bar disposed in the display shelf 12, a wire connected to the light bar, and components such as the main control circuit board 111, a power socket 112, a power switch 113, and an adapter socket 114 disposed within the display shelf 13. The light emitted from the light bar is able to pass through a light transmission region of the bottom plate 121, an end of the wire away from the light bar is provided with an adapter plug 126, the power socket 112 is connected to the main control circuit board 111 and exposed through one through hole pair 16 to allow for the setting of a power adapter for the display stand 10. The power switch 113 is connected to the main control circuit board 111 and exposed through one through hole pair 16 to allow a user to turn on/off the display stand 10. The adapter socket 114 is connected to the main control circuit board 111 and exposed through another through hole pair 16 to allow the adapter plug 126 to be connected to the adapter socket 114. The light bar and at least a portion of the wire are not visible as they are obscured by the cover plate 125.

It should be noted that the through hole pair 16 of the present disclosure refers to that in the region where the bottom plate 121 overlaps the side plate 132, a first through hole is provided on the bottom plate 121, a second through hole is provided on the side plate 132, and the first and second through holes are at least partially overlapped after the display shelf 12 and the display shelf 13 are assembled. Hole diameters of the first through hole and the second through hole are the same or different; and counts of the first through hole and the second through hole are the same or different. For example, referring to FIG. 2 and FIG. 4, there are two first through holes and three second through holes, and after the display shelf 12 and the display shelf 13 are assembled, one first through hole overlaps one second through hole to form one through hole pair 16, and another first through hole overlaps with the remaining two second through holes to form two through hole pairs 16.

In some embodiments, the display stand 10 includes the main control circuit board 111 disposed within the display shelf 13, and a side of the bottom plate 131 away from the side plate 132 is divided into a first display region 13a and a second display region 13b. An area of the first display region 13a is less than an area of the second display area 13b. The display stand 10 includes a showcase 135 which is located in the first display region 13a. The showcase 135 is removably connected to the bottom plate 131. The showcase 135 is used to display a displayed object 22 that can not be experienced by the user, so as to allow the showcase 135 and the displayed object 22 to be taken as a replaceable module for the easy replacement. The second display region 13b is used to display the displayed object 21 that is able to be experienced by the user, and the displayed object 21 is connected to the main control circuit board 111 through the wire 30. The displayed object 22 and the displayed object 21 may be the same or similar, for example, both of the displayed object 22 and the displayed object 21 are earphones. The displayed object 22 and the displayed object 21 may also be different, for example, the displayed object 21 and the displayed object 22 are an earphone and a charging case for the earphones, respectively.

Further, a side of the bottom plate 131 away from the side plate 132 is divided into a third display region 13c and a fourth display region 13d. An area of the third display region 13c is less than an area of the fourth display region 13d. The third display region 13c is located at the side of the first display region 13a away from the display shelf 12 and is provided with a nameplate at least including product information of the displayed object 21. The fourth display region 13d is located at the side of the second display region 13b away from the display shelf 13, and the fourth display region 13d is provided with a key assembly 40 for the user to control the display stand 10.

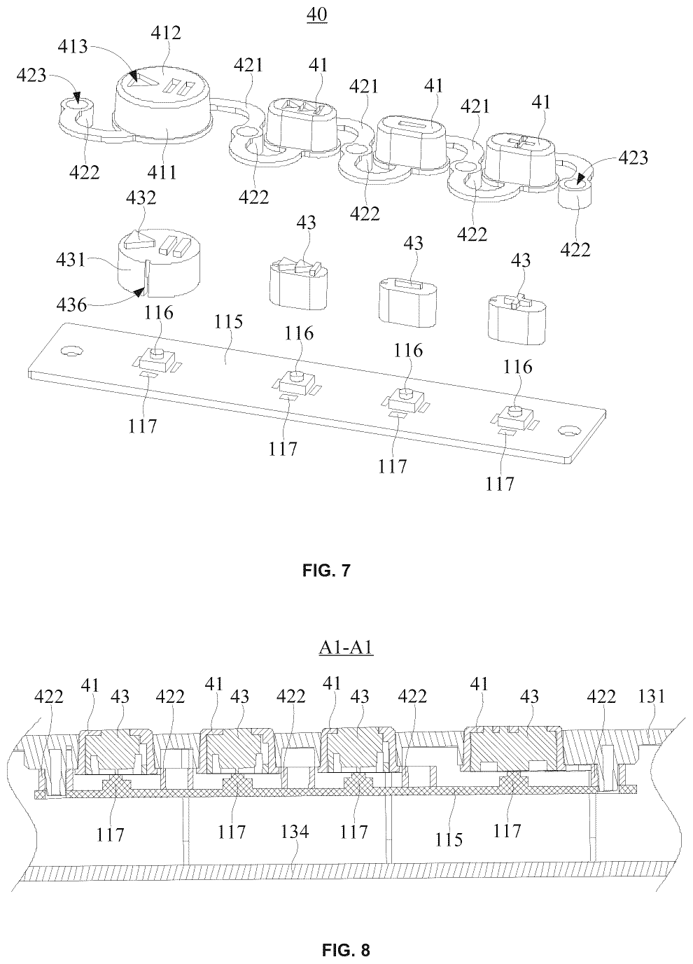

Exemplarily, referring to FIG. 7 and FIG. 1, the key assembly 40 includes a plurality of keys 41 and one or more connecting bars 421 connecting the plurality of keys 41, such as the four keys 41 shown in FIG. 7 and FIG. 1. The one or more connecting bars 421 allow any key of the keys 41 to be movable under an external force. Each of the plurality of keys 41 includes a cylindrical sidewall 411 connected to the connecting bar 421 and an end wall 412 integrally connected to one end of the cylindrical sidewall 411. The end wall 412 is disposed with hollow graphics 413. The hollow graphics 413 include at least one of the play/pause key, the next song key, the volume down key, the volume up key, etc. Correspondingly, the connecting bar 421 is located at the other end of the cylindrical sidewall 411 away from the end wall 412. Further, the key assembly 40 includes light-transmitting members 43 installed inside the plurality of keys 41, the light-transmitting members allow the key assembly 40 to be lighted. Each light-transmitting member 43 includes a columnar body 431 and a graphic protrusion 432 connected to the columnar body 431. The columnar body 431 is disposed in the cylindrical sidewall 411, and the graphic protrusion 432 is disposed within the hollow graphics 413. In this way, as the light-transmitting member 43 is mounted inside the key 41, that is, the light-transmitting member 43 and the key 41 are processed separately and then assembled, the selection of the material of the key 41 and the light-transmitting member 43 is made more flexible, and a related mold forming is made simpler, which helps to reduce the manufacturing cost of the key assembly 40.

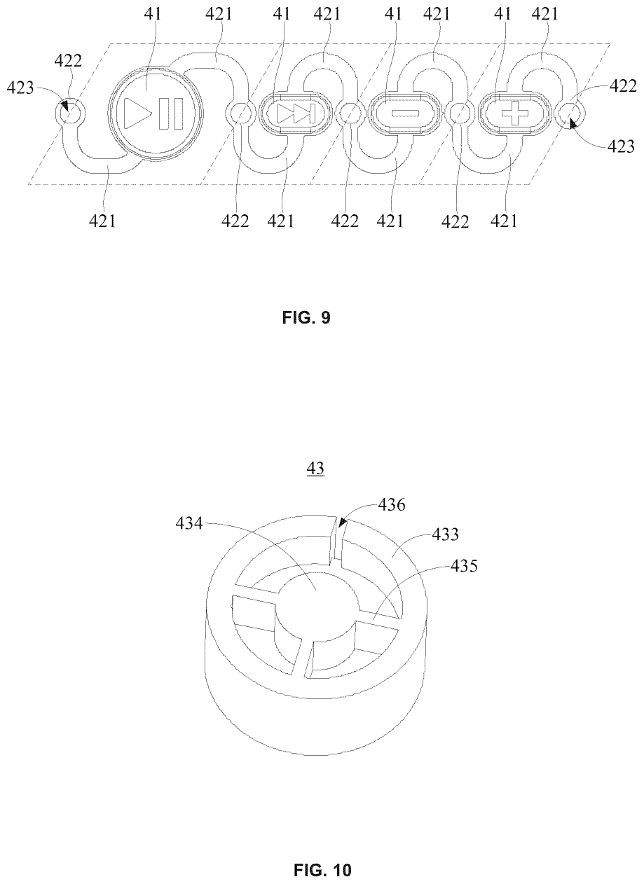

In some embodiments, referring to FIG. 8 and FIG. 9, all of the plurality of keys 41 and the one or more connecting bars 421 are divided into single key blocks with the same count of the count of the plurality of keys 41, such as the four single key blocks shown in the dashed boxes in FIG. 8. Each single key block includes one key 41 and two connecting bars 421, and an end of each connecting bar 421 not connected to the key 41 is provided with a support block 422. The support block 422 is used to contact an auxiliary circuit board 115 to make the connecting bar 421 in a suspended state with respect to the auxiliary circuit board 115, thereby allowing the plurality of keys 41 to be movable with respect to the auxiliary circuit board 115 under an external force. In this way, as two sides of each key 41 are supported separately by the support block 422, it is not only conducive to maintaining a relative positional relationship between each key 41 with the light-transmitting member 43 thereof and the auxiliary circuit board 115, but also facilitates the smooth motion of each key 41 toward the auxiliary circuit board 115 when the key 41 is pressed. Furthermore, two adjacent single key blocks share one single support block 422, which is conducive to simplifying a structure of the key assembly 40. At this time, all of the keys 41, the one or more connecting bars 421, and the support blocks 422 are integrally molded structural members. When viewed in a pressing direction of the key assembly, geometric centers of all of the support blocks and geometric centers of all the plurality of keys are set to be co-linear, to allow for the various points on any one of the keys 41, when pressed, to be uniformly subjected to the external force, and to return smoothly to the original position after the press ends. Furthermore, when viewed in the pressing direction of the key assembly 40, each connecting bar 421 is set in an arc shape, which not only facilitates the reduction in a volume of the key assembly 40 to allow a greater journey of any of the keys 41 when pressed, thereby decreasing a risk for the one or more connecting bars 421 to break from the keys 41. The two connecting bars 421 in each single key block are set to be rotationally symmetrical, and a center of symmetry is the geometric center of the corresponding key 41 to allow for the various points on the key 41, when pressed, to be uniformly subjected to the external force, and to return smoothly to the original position after the press ends. Further, the two most widely spaced of all of the support blocks 422 are each provided with a mounting hole 423 to allow the key assembly 40 to be fixed at the mounting hole 423, e.g., the connecting bars 421 are fixed to the bottom plate 131 at the support blocks 422 by screws. Referring to FIG. 7 to FIG. 9, except for the two support blocks 422 with the greatest spacing are provided with the mounting holes 423, respectively, the other support blocks 422 are disposed with the mounting holes 423, too, which helps to reduce the cost of the key assembly 40.

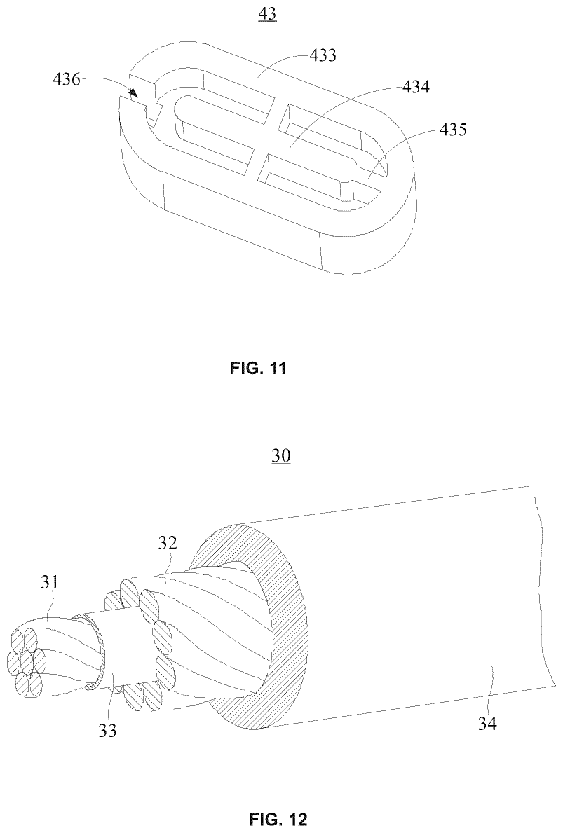

In some embodiments, referring to FIG. 10 and FIG. 11, the light-transmitting member 43 includes a columnar inner core 434 and a cylindrical outer wall 433 that is connected to an end of the columnar body 431 away from the graphic protrusion 432. The columnar inner core 434 is disposed at an inner side of the cylindrical outer wall 433, and used for triggering a switching device 116 under the action of the external force. The cylindrical outer wall 433 and the columnar inner core 434 are further connected by a plurality of reinforcement bars 435 spaced around the columnar inner core 434. Furthermore, the inside of the cylindrical sidewall 411 is provided with a convex strip extending along an axial direction of the key 41, and the cylindrical outer wall 433 is provided with a groove 436 extending along an axial direction of the light-transmitting member 43, the convex strip is located inside the groove 436 for fool proofing in a process of assembly of the light-transmitting member 43 and the key 41, so that the graphic protrusion 432 is within the hollow graphics 413. The groove 436 is located between two adjacent reinforcement bars 435 in a circumferential direction of the light-transmitting member 43, and makes at least a portion of the cylindrical outer wall 433 discontinuous along the circumferential direction of the light-transmitting member 43. Further, all of the grooves 436 and the reinforcement bars 435 are uniformly spaced apart in the circumferential direction of the light-transmitting member 43.

In some embodiments, the display stand 10 includes the auxiliary circuit board 115 disposed within the display shelf 13, and the key assembly 40 is also disposed within the display shelf 13 and partially exposed so as to be pressed by the user. The key assembly 40 is connected to the bottom plate 131 through the one or more connecting bars 421 and makes the plurality of keys 41 to be exposed through the through holes on the bottom plate 131 respectively. The auxiliary circuit board 115 is disposed on a side of the key assembly 40 away from the bottom plate 131, and is connected to the bottom plate 131 to support the key assembly 40. Furthermore, the auxiliary circuit board 115 is disposed with a plurality of switching devices 116 and a plurality of light beads 117, for example, four switching devices 116 and sixteen light beads 117 shown in FIG. 7. The plurality of switching devices 116 are disposed in a one-to-one correspondence with the plurality of keys 41 to allow the plurality of keys 41 to trigger the corresponding switching devices 116 through the light-transmitting member 43 under the action of an external force, thereby controlling the displayed object 21. Each of the plurality of keys 41 is provided corresponding to at least one of the light beads 117, for example, as shown in FIG. 7, the one key 41 is disposed corresponding to four light beads 117. The light transmitted from the plurality of light beads 117 is transmitted through the corresponding light-transmitting member 43 to allow the key assembly 40 to be lighted. Correspondingly, the display stand 10 includes the main control circuit board 111 connected to the bottom plate 131. The auxiliary circuit board 115 is connected to the main control circuit board 111. The control signals generated by the triggering of the switching devices 116 are transmitted to the main control circuit board 111. It is noted that the auxiliary circuit board 115 and the main control circuit board 111 are merged into a single circuit board, and one of the four light beads 117 surrounding each switching device 116 in FIG. 7 is invisible as it is blocked by the switch device 116.

Based on the above detailed description, for the display shelf 12 and the display shelf 13, shapes of the bottom plate 121 and the bottom plate 131 are respectively set to any of the shapes of a triangle, a rectangle, a semicircle, etc., and shapes of the side plate 122 and the side plate 132 are in accordance with the shapes of the bottom plate 121 and the bottom plate 131, respectively. Based on this, the shapes of the bottom plate 121 and the bottom plate 131 are combined according to actual needs, for example, the shapes of the bottom plate 121 and the bottom plate 131 are a rectangle or a semicircle, or one of the shapes of the bottom plate 121 and the bottom plate 131 is a rectangle, and the other is a semicircle. Furthermore, the display stand 10 includes only one of the display shelf 13 and the display shelf 13, and may likewise display at least one of the displayed object 21 and the displayed object 22. For example, the display stand 10 includes only the display shelf 13. The main control circuit board 111 and the electronics thereon, the auxiliary circuit board 115 and the electronics thereon, and the key assembly 40 are disposed inside the display shelf 13. The displayed object 21 is connected to the main control circuit board 111 through the wire 30. The displayed object 22 and the showcase 135 thereof are detachably connected to the display shelf 13.

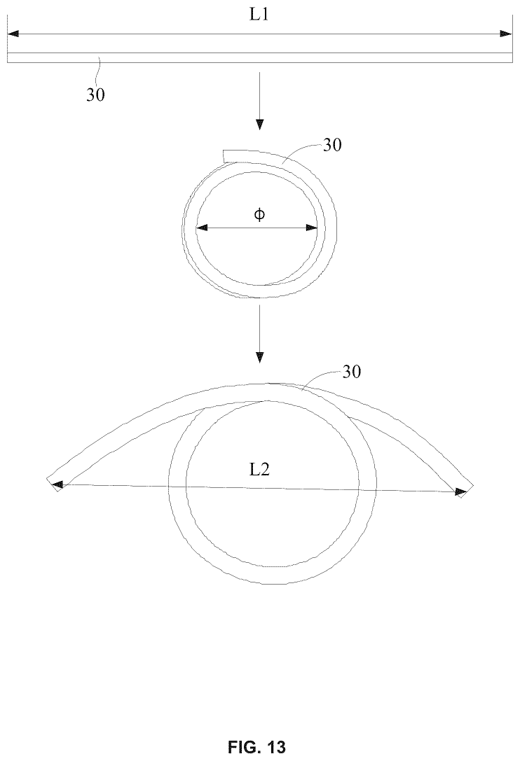

Exemplarily, referring to FIG. 12 and FIG. 1, the wire 30 includes a first conductive core wire 31 and a second conductive core wire 32 electrically insulated from each other, e.g., at least one of the first conductive core wire 31 and the second conductive core wire 32 is wrapped with an electrically insulating layer 33, and an elastic covering 34 covers the first conductive core wire 31 and the second conductive core wire 32. The resiliency of the elastic covering 34 is better than the resiliency of any one of the first conductive core wire 31 and the second conductive core wire 32 to allow the wire 30 to stretch under the elasticity of the elastic covering 34 after being coiled, which helps to reduce the probability of tangling of the wire 30. Furthermore, referring to FIG. 13, the wire 30 of length L1 is coiled two times with a diameter of 10 cm and then rested for 24 hours, and then a distance between two endpoints of the wire after stretching is measured to be L2, wherein L2/L1≥0.6, so as to allow the wire 30 to stretch to a greater extent to its initial state after being coiled. Preferably, L2/L1≥0.8.

In some embodiments, a material of the elastic covering 34 includes at least one of the thermoplastic urethane (TPU), thermoplastic vulcanizate (TPV), and thermoplastic polyeher ester elastomer (TPEE), which have a good resilience.

In some embodiments, a ratio of a wall thickness of the elastic covering 34 to a total diameter of the first conductive core wire 31 and the second conductive core wire 32 is in a range of 0.2-0.25. If the aforementioned ratio is too small, it makes the elastic covering 34 difficult to make the wire 30 to stretch after being coiled. If the aforementioned ratio is too large, it makes the wire 30 to be difficult to be coiled. Further, the first conductive core wire 31 is multi-stranded wires, so that the first conductive core wire 31 is becoming softer. The second conductive core wire 32 is multi-stranded wires, so that the second conductive core wire 32 is becoming softer. The second conductive core wire 32 is stranded on the first conductive core wire 31.

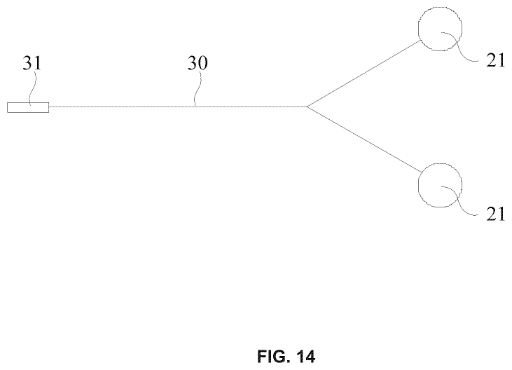

In some embodiments, the elastic covering 34 has a transparent structure, and the second conductive core wire 32 is a multi-stranded wire stranded on the first conductive core wire 31 to show the metallic coloration of the second conductive core wire 32 and to make the wire 30 to look like an anti-theft wire in appearance, which is simple, reliable, and cheap. Referring to FIG. 14, the wire 30 is set as a Y-shaped wire and used to connect the two displayed objects 21. The displayed objects 21 are earphones. In other words, the displayed objects 21 are two earphones, and the wire 30 is set as a Y-shaped wire to connect the two earphones. In this way, as the wire 30 looks like an anti-theft wire, the displayed object 21 is kept from being taken away. Furthermore, there is a color difference between the color of the second conductive core wire 32 and the color of the first displayed object 21, which helps to avoid that the wire 30 is mistakenly considered to a part of the displayed object 21.

In some embodiments, the main control circuit board 111 transmits signals, such as audio signals, to the displayed object 21 through the first conductive core wire 31 and the second conductive core wire 32, so as to facilitate the user to experience the displayed object 21. The main control circuit board 111 is provided with a socket terminal, and one end of the wire 30 is provided with a plug terminal 35. The plug terminal 35 is plug-connected to the socket terminal to allow the displayed object 21, the wire 30, and the plug terminal 35 to act as a replaceable module. In this way, as the displayed object 21 is set as the replaceable module and is plug-connected to the main control circuit board 111, the display stand 10 changes minimally after the displayed object 21 is replaced, thus increasing the versatility of the display stand 10 and reducing the cost of the display stand 10.

In some embodiments, a yellowness index of the elastic covering 34 is level 0 or level 1, and preferably is level 0. The yellowness index (ΔYI) indicates a difference in the yellowness index (YI) of the material before and after a yellowing test, and the yellowness index (YI) is used to indicate a degree of yellowing of a colorless transparent, semi-transparent, or near-white polymer material. The yellowing test includes at least one of the thermo-oxidative aging and the photo-oxidative aging. Obviously, the lower the yellowness index, the less the material turns yellow.

In some embodiments, the material of the elastic covering 34 include a thermoplastic polyester elastomer, which not only has a good elasticity, but is also transparent and less prone to yellowing.

Hereinafter, different types of yellowing tests are conducted on the wire 30 to verify the reliability of the wire 30 when the material of the elastic covering 34 is the thermoplastic polyester elastomer, as shown in the following table.

| Yellowing | | | | |
|---|---|---|---|---|
| test | Test overview | Test purpose | Test method and condition | Test result |
| #1 | Long-term | Evaluate | 1. The test sample was | No |
| | ultraviolet | whether the | radiated at 60° C. for 4 h (UV- | discoloration |
| | (UV) aging | wire | A, 340 nm, 077 W/m²), and | or cracking |
| | test-340 nm | undergoes | condensed at 50° C. for 4 h, | |
| | | discoloration, | with a cycle of 8 h, and a | |
| | | cracking, | total of 12 cycles were | |
| | | etc., after a | tested; | |
| | | long period | 2. A room temperature | |
| | | of time | recovery was performed for | |
| | | exposure to | 2 h after the test, and the | |
| | | outdoor | test sample was compared | |
| | | sunlight and | with a comparison sample. | |
| | | moisture | | |
| | | (two-year life | | |
| | | simulation) | | |
| #2 | Short-term | Evaluate | 1. The test sample was | No |
| | UV aging | whether the | radiated at 60° C. for 4 h (UV- | discoloration |
| | test-340 nm | wire | A, 340 nm, 077 W/m²), and | or cracking |
| | | undergoes | condensed at 50° C. for 4 h, | |
| | | discoloration, | with a cycle of 8 h, and a | |
| | | cracking, | total of 1 cycle was tested; | |
| | | etc., after a | 2. A room temperature | |
| | | short-term | recovery was performed for | |
| | | exposure to | 2 h after the test, and the | |
| | | outdoor | test sample was compared | |
| | | sunlight and | with a comparison sample. | |
| | | moisture | | |
| | | (two-month | | |
| | | life | | |
| | | simulation). | | |
| #3 | Continuous | Evaluate | 1. The test sample is | No |
| | UV aging | whether the | radiated at 60° C. for 8 h (UV- | discoloration |
| | test-340 nm | wire | A, 340 nm, 077 W/m²); | or cracking |
| | | undergoes | 2. A room temperature | |
| | | discoloration, | recovery was performed for | |
| | | cracking, | 2 h after the test, and the | |
| | | etc., after a | test sample was compared | |
| | | short-term | with a comparison sample. | |
| | | continuous | | |
| | | exposure to | | |
| | | outdoor | | |
| | | sunlight and | | |
| | | moisture for | | |
| | | three days | | |
| #4 | Xenon light | Evaluate | The test sample was placed | No |
| | aging test- | whether the | in a test box, a test was | discoloration |
| | 420 nm | wire | performed by simulating an | or cracking |
| | | undergoes | indoor light radiation and | |
| | | discoloration, | temperature for a cycle of | |
| | | cracking, | 24 h, specifically, at 40° C. in | |
| | | etc., after a | dry heat, the xenon light | |
| | | continuous | was set to radiate the test | |
| | | exposure to | sample in a 420 nm band at | |
| | | indoor light | an irradiance of 0.55 W/m² | |
| | | | for 20 h, and then the xenon | |
| | | | light was turned off for 4 h, | |
| | | | and a total of 3 cycles of | |
| | | | test was performed; then | |
| | | | the test sample was | |
| | | | compared with the | |
| | | | comparison sample. | |
| #5 | Xenon light | Evaluate | The test sample was placed | No |
| | aging test- | whether the | in a test box, a test was | discoloration |
| | 340 nm | wire | performed by simulating an | or cracking |
| | | undergoes | indoor light radiation and | |
| | | discoloration, | temperature for a cycle of | |
| | | cracking, | 24 h, specifically, at 40° C. in | |
| | | etc., after a | dry heat, the xenon light | |
| | | continuous | was set to radiate the test | |
| | | exposure to | sample in a 340 nm band at | |
| | | indoor light | an irradiance of 0.55 W/m² | |
| | | | for 20 h, and then the xenon | |
| | | | light was turned off for 4 h, | |
| | | | and a total of 3 cycles of | |
| | | | test was performed; then | |
| | | | the test sample was | |
| | | | compared with the | |
| | | | comparison sample. | |

The foregoing is only a part of the embodiments of the present disclosure, and is not intended to limit the scope of protection of the present disclosure, and any equivalent device or equivalent process transformations utilizing the contents of the present disclosure and the accompanying drawings, or applying them directly or indirectly in other related technical fields, are similarly included in the scope of patent protection of the present disclosure.

1. A display device, including: a display stand, a wire, and a first displayed object, wherein
the display stand is equipped with a main control circuit board, wherein the display stand includes a first display shelf, a second display shelf, and a fastener, and the fastener is configured to pass through the first display shelf and is threadedly connected to the second display shelf, and
the first displayed object is able to be experienced by a user and is connected to the main control circuit board through the wire.

2. The display device of claim 1, wherein the first display shelf including a first bottom plate, and a first side plate and a protruding platform connected to the first bottom plate, wherein
the protruding platform and the first side plate are located on a same side of the first bottom plate,
the protruding platform is disposed with a first through hole section, a second through hole section, and a third through hole section connecting the first through hole section and the second through hole section,
the second through hole section is further away from the first bottom plate than the first through hole section,
the third through hole section has a smallest hole diameter among the first through hole section, the second through hole section, and the third through hole section,
the fastener includes a head portion, a bare bar portion connected to the head portion, and a threaded portion connected to the bare bar portion,
a diameter of the threaded portion is greater than a hole diameter of the third through hole section and less than a smaller one of a hole diameter of the first through hole section and a hole diameter of the second through hole section, and
the fastener is configured to pass through the second through hole section, the third through hole section, and the first through hole section, and is threadedly connected to the second display shelf through the threaded portion.

3. The display device of claim 2, wherein a ratio of a depth of the third through hole section to a length of the threaded portion is in a range of 0.6-1.

4. The display device of claim 2, wherein the bare bar portion includes a first bare bar section and a second bare bar section, wherein
the first bare bar section is closer to the threaded portion compared to the second bare bar section,
a diameter of the first bare bar section is smaller than a diameter of the second bare bar section, and
the diameter of the second bare bar section is greater than the hole diameter of the third through hole section.

5. The display device of claim 4, wherein a ratio of the hole diameter of the second through hole section to the diameter of the second bare bar section is in a range of 0.2-0.4.

6. The display device of claim 4, wherein a ratio of a length of the first bare bar section to a sum of a depth of the first through hole section and a depth of the third through hole section is in a range of 1-1.5.

7. The display device of claim 6, wherein
the depth of the first through hole section is greater than or equal to a length of the threaded portion, and
a depth of the second through hole section is greater than or equal to a length of the second bare bar section.

8. The display device of claim 2, wherein
a ratio of a height of the protruding platform to a height of the first side plate is in a range of 0.7-1, and
a minimum spacing between a center of any one of the second through hole section, the third through hole section, and the first through hole section of the protruding platform and the first side plate is in a range of 10 mm-12 mm.

9. The display device of claim 2, wherein a depth of the third through hole section is in a range of 2 mm-4 mm.

10. The display device of claim 2, wherein the second display shelf includes a second bottom plate and a second side plate connected to the second bottom plate,
the protruding platform is disposed in a region where the first bottom plate overlaps the second side plate, and
the fastener makes the first bottom plate to abut against the second side plate.

11. The display device of claim 10, wherein the first display shelf includes a partition plate connected to the first bottom plate,
the partition plate divides a first accommodation space enclosed by the first side plate and the first bottom plate into a first accommodation sub-region and a second accommodation sub-region,
a volume of the first accommodation sub-region is smaller than a volume of the second accommodation sub-region, and
the protruding platform is located in the first accommodation sub-region and connected to the first side plate and the partition plate respectively through one or more reinforcement bars.

12. The display device of claim 10, wherein the first side plate and the first bottom plate enclose a first accommodation space, and the second side plate and the second bottom plate enclose a second accommodation space, wherein
there are a plurality of protruding platforms,
a plurality of through hole pairs are disposed in the region where the first bottom plate overlaps the second side plate,
the plurality of through hole pairs and the plurality of protruding platforms are alternately arranged, and
each of the plurality of through hole pairs enables the first accommodation space to be communicated with the second accommodation space.

13. (canceled)

14. The display device of claim 10, wherein
a side of the second bottom plate away from the second side plate is divided into a first display region and a second display region,
the display stand includes a showcase which is located in the first display region and is removably connected to the second bottom plate,
the showcase is configured to display a second displayed object that cannot be experienced by the user, so as to allow the showcase and the second displayed object to be taken as a replaceable module, and
the second display region is configured to display the first displayed object.

15. The display device of claim 1, wherein the display stand includes a display shelf, a key assembly, and an auxiliary circuit board, wherein
the display shelf is configured to display the first displayed object, and includes a bottom plate and a side plate connected to the bottom plate,
the key assembly includes a plurality of keys and one or more connecting bars connecting the plurality of keys,
the one or more connecting bars allows any key of the plurality of keys to be movable under an external force,
the key assembly is connected to the bottom plate through the one or more connecting bars, and makes the plurality of keys to expose through through holes on the bottom plate respectively,
each of the plurality of keys includes a cylindrical sidewall connected to the one or more connecting bars and an end wall integrally connected to one end of the cylindrical sidewall,
the end wall is disposed with hollow graphics,
the key assembly includes light-transmitting members installed inside the plurality of keys, the light-transmitting members allow light to pass through,
each of the light-transmitting member includes a columnar body and a graphic protrusion connected to the columnar body,
the columnar body is disposed in the cylindrical sidewall,
the graphic protrusion is disposed in the hollow graphics,
the auxiliary circuit board is located on a side of the key assembly away from the bottom plate, and is connected to the bottom plate,
the auxiliary circuit board is disposed with a plurality of switching devices and a plurality of light beads,
the plurality of the switching devices are disposed in a one-to-one correspondence with the plurality of keys,
the plurality of keys trigger the corresponding switching devices through the light-transmiting member under an action of the external force to control the first displayed object,
each of the plurality of keys is disposed correponding to at least one of the plurality of light beads, and
a light transmitted from the plurality of light beads is transmitted through the corresponding light-transmitting member.

16. The display device of claim 15, wherein
all of the plurality of keys and the one or more connecting bars are divided into single key blocks with a same count as the plurality of keys, wherein
each of the single key blocks includes one of the plurality of keys and two of the one or more connecting bars,
an end of each of the one or more connecting bars not connected to the plurality of keys is provided with a support block, and
the support block contacts the auxiliary circuit board to allow the one or more connecting bars to be in a suspended state relative to the auxiliary circuit board.

17. The display device of claim 16, wherein
two adjacent single key blocks share one support block, and
when viewed in a pressing direction of the key assembly, geometric centers of all of the support blocks and geometric centers of all the plurality of keys are set to be co-linear.

18. The display device of claim 17, wherein when viewed along the pressing direction, each connecting bar is set in an arc shape, and the two connecting bars in each single key block is set to be rotationally symmetrical.

19. The display device of claim 17, wherein two support blocks with a greatest space among all of the support blocks are each provided with a mounting hole to allow the key assembly to be fixed at the mounting hole.

20. The display device of claim 15, wherein at least one of the light-transmitting members includes a cylindrical outer wall and a columnar inner core connected to an end of the columnar body away from the graphic protrusion, wherein
the columnar inner core is disposed at an inner side of the cylindrical outer wall, and configured to trigger the switching device under the action of the external force,
the cylindrical outer wall and the columnar inner core are further connected by a plurality of reinforcement bars spaced around the columnar inner core,
the cylindrical sidewall is provided with a convex strip extending along an axial direction of the key on the inside of the cylindrical side wall,
the cylindrical outer wall is provided with a groove extending in an axial direction along the light-transmitting member,
the groove is located between two adjacent reinforcement bars in a circumferential direction of the light-transmitting member and makes at least a portion of the cylindrical outer wall discontinuous along the circumferential direction of the light-transmitting member, and
the convex strip is disposed within the groove.

21. The display device of claim 1, wherein the wire includes a first conductive core wire and a second conductive core wire electrically insulated from each other and an elastic covering wrapping the first conductive core wire and the second conductive core wire,
the main control circuit board transmits signals to the first displayed object through the first conductive core wire and the second conductive core wire,
the elastic covering has a resilience superior to a resilience of either of the first conductive core wire and the second conductive core wire to allow the wire to stretch under the resilience of the elastic covering after the elastic covering is coiled; wherein
the wire of length L1 is coiled two times with a diameter of 10 cm and then rested for 24 hours, and then a distance between two endpoints of the wire after stretching is measured to be L2, wherein L2/L1≥0.6.

22-30. (canceled)
